(19) United States
(12) Patent Application Publication
(10) Pub. No.: US 2006/0052882 A1
(43) Pub. Date: Mar. 9, 2006

(54) Real-time monitoring using sensor networks

(76) Inventors: Uwe Kubach, Waldbronn (DE); Christian Decker, Karisruhe (DE)

Correspondence Address: FISH & RICHARDSON, P.C., PO BOX 1022, MINNEAPOLIS, MN, 55440-1022, US

(21) Appl. No.: 11/021,477

(22) Filed: Dec. 23, 2004

Related U.S. Application Data
(60) Provisional application No. 60/606,998, filed on Sep. 3, 2004.

(51) Int. Cl. G05B 19/18

(52) U.S. Cl. 700/11; 700/2

(57) ABSTRACT

Systems, methods and computer program products implementing techniques for real-time monitoring using sensor networks. A system implementing the techniques comprises a business application, a sensor network, and a communication link between the sensor network and the business application. The sensor network includes a plurality of sensor nodes, each sensor node being an electronic device that includes a sensor, a processor, memory, and inter-node communication logic that allows the sensor node to communicate bi-directionally with other sensor nodes in the plurality of sensor nodes, and the sensor network is configured to receive business logic from the business application through the communication link, and to execute the business logic on the sensor nodes.

### CROSS REFERENCE TO RELATED APPLICATIONS

This application claims the benefit of U.S. Provisional Application No. 60/606,998, filed Sep. 3, 2004, and entitled “Real-Time Monitoring Using Sensor Networks.”

### BACKGROUND

The present invention relates to data processing by digital computer, and more particularly to real-time monitoring using sensor networks.

In conventional systems for real-time monitoring using sensor networks, very little, if any, processing is performed by the sensor networks themselves. Instead, the sensor networks typically transmit their sensor data to a backend system and the processing is performed by the backend system. Any processing that is performed by sensor networks is generally limited to collecting and transmitting the sensor data, and in some cases, batching up the sensor data before transmission.

### SUMMARY OF THE INVENTION

Systems, methods and computer program products implementing techniques for real-time monitoring using sensor networks.

In one general aspect, a system implementing the techniques includes a business application, a sensor network, and a communication link between the sensor network and the business application. The sensor network includes a plurality of sensor nodes, each sensor node being an electronic device that includes a sensor, a processor, memory, and inter-node communication logic that allows the sensor node to communicate bi-directionally with other sensor nodes in the plurality of sensor nodes, and the sensor network is configured to receive business logic from the business application through the communication link, and to execute the business logic on the sensor nodes.

Implementations may include one or more of the following features.

The business logic may include a set of rules, each rule specifying a condition and an action to be performed when the condition is met. The action may be to raise an alert.

Executing the business logic may include resolving a rule in the set of rules.

Resolving a rule in the set of rules may include replacing a variable in the condition with a sensor value, determining whether the condition is met, and if the condition is met, performing the action specified by the rule.

The inter-node communication logic may be RF (Radio Frequency) logic.

Each sensor node may be configured to detect other sensor nodes in proximity to the sensor node, and upon such detection, send a message to the other sensor nodes, the message may include an identifier for the sensor node and a sensor value read from the sensor on the sensor node.

The rules may specify storage requirements, the storage requirements may include one or more of temperature requirements, humidity requirements, storage time requirements, and storage capacity requirements.

The sensor network may be located in a physical storage facility and each sensor node may be attached to a physical item stored in the physical storage facility.

The business application may be a product lifecycle management application.

The plurality of sensor nodes may include a monitoring node that handles all communication between the sensor network and the business application.

In another general aspect, the techniques include establishing communication between a sensor node within a sensor network and a business application, receiving business logic from the business application, and executing the business logic on the sensor node.

Implementations may include one or more of the following features.

The business logic may include a set of rules, each rule specifying a condition and an action to be performed when the condition is met. The action may be to raise an alert.

Executing the business logic may include resolving a rule in the set of rules.

Resolving a rule in the set of rules may include replacing a variable in the condition with a sensor value, determining whether the condition is met, and if the condition is met, performing the action specified by the rule.

The techniques may further include detecting other sensor nodes in proximity to the sensor node, and upon such detection, sending a message to the other sensor nodes, the message including an identifier for the sensor node and a sensor value read from the sensor on the sensor node.

The rules may specify storage requirements, the storage requirements including one or more of temperature requirements, humidity requirements, storage time requirements, and storage capacity requirements.

The sensor network may be located in a physical storage facility and each sensor node may be attached to a physical item stored in the physical storage facility.

The sensor network may include a monitoring node that handles all communication between the sensor network and the business application.

Implementations can realize one or more of the following advantages. Business logic from a backend business application can be passed down to a sensor network and be executed directly on the sensor network. This allows the business logic to be executed closer to the point of action and allows the business logic to be executed in remote areas where no computer infrastructure is available. This also reduces the frequency and amount of communication between the sensor network and the business application. The business application can work with a large number of sensors without being overloaded with sensor data.

The business application does not need to communicate with all the nodes in the sensor network. All communication between the business application and the sensor can be handled by a single node within the sensor network.

One implementation realizes all of the above advantages.

Details of one or more implementations are set forth in the accompanying drawings and in the description below. Further features, aspects, and advantages will become apparent from the description, the drawings, and the claims.

### BRIEF DESCRIPTION OF THE DRAWINGS

FIG. 1 is a block diagram of a system for real-time monitoring using sensor networks.

FIG. 2 illustrates business logic.

FIG. 3 illustrates one implementation of the system.

FIGS. 4A-4C illustrate collaboration among sensor nodes.

Like reference numbers and designations in the various drawings indicate like elements.

### DETAILED DESCRIPTION

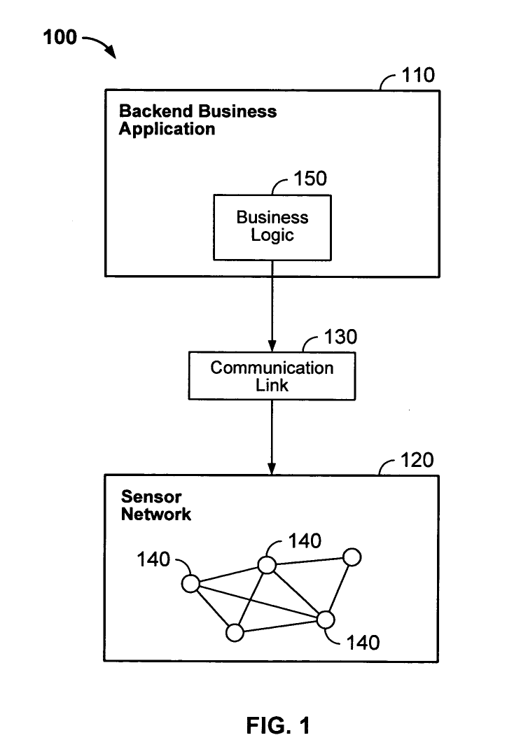

As shown in FIG. 1, a system 100 includes a backend business application 110 and a sensor network 120. The sensor network 120 communicates with the backend business application 110 through a communication link 130.

During system operation, the sensor network 120 receives business logic from the business application 110 through the communication link 130 and executes the business logic on the sensor network 120 through collaboration and communication among the individual nodes 140 of the sensor network 120, as will be described below.

Each sensor node 140 is an electronic device that includes a sensor, a processor, memory, and inter-node communication logic. The sensor can detect a variety of different environmental conditions including, but not limited to, acceleration, temperature, sound and light, movement and proximity to other sensor nodes. The processor and memory are of sufficient speed and size so as to enable business logic to be executed directly on the node. The inter-node communication logic allows the sensor node to communicate bi-directionally with other sensor nodes. In one implementation, the inter-node communication logic is an RF (Radio Frequency) transceiver.

The sensor node 140 can be implemented using conventional sensor node technology, for example, the Intel Motes technology developed by Intel Corporation of Santa Clara, Calif. or the Particles technology developed by the University of Karlsruhe at Karlsruhe, Germany (http://particle.teco.edu).

Inter-Node Communication

Sensor nodes can propagate messages to other sensor nodes in their close proximity. These messages usually contain an identification of the sensor node emitting the message. Additionally, the message can contain information about a physical item to which the sensor node is attached. This information can include the contents of the physical item and the current condition of the physical item (e.g., corrosion level, temperature, and so on). The sensor node can obtain this information by using its sensor to measure the current condition of the physical item.

The message data is strictly typed. In one implementation, the message format is based on tuples. A tuple consists of a message type identifier followed by message data. The following is an example of a tuple:
“LLL xxxx”.

This example shows a three-letter message type identifier (“LLL”) followed by arbitrary data (“xxxx”). This tuple syntax is understood by other sensor nodes. The interpretation of the message type identifier is specified by the business logic. Parsing these tuples, other sensor nodes are aware of what is going on at the emitting node.

Monitoring Node

In one implementation, one of the sensor nodes 140 is responsible for all communication between the sensor network 120 and the business application 110. Such a node will be referred to as a monitoring node. In this manner, the business application 110 does not need to communicate with each of the sensor nodes individually. Instead, the business application 110 only communicates with the monitoring node. The monitoring node receives business logic from the business application and executes the business logic by applying its own sensor values and also the sensor values that it receives from the other sensor nodes. It is also possible that the monitoring node propagates portions of the business logic to other sensor nodes to be executed by the other sensor nodes.

Any node in the sensor network 120 can be selected to be the monitoring node. In one implementation, the selection is based on the node's physical proximity to the communication 130. A close proximity enables a direct wireless connection to the communication link 130. Over time, the monitoring node designation may be swapped to a different node. Such node swapping can be triggered by the business logic received from the business application. For example, the business logic may specify node swapping based on changes in the local topography. For instance, if there is a change in the topography or arrangement of the physical items being monitored, a more central node among all physical items might be selected to be the monitoring node. A centrally located node can communicate with more sensor nodes than a node that is at the edge of the topography.

A sensor network 120 can have more than one monitoring node, for example, to for load-balancing or backup purposes.

Business Logic

The business logic includes a set of rules. Each rule specifies a condition and an action. The rules are resolved, meaning that the condition is evaluated to true or false, and the actions are executed when the condition is true. The resolution of rules is done on the sensor network 120 according to the sensor data obtained through the sensors. This resolution occurs in real time on the sensor network 120. To allow for this real-time resolution to occur, the business logic must first be transferred from the business application 110 down to the sensor network 120. Depending on how the business logic is represented in the business application, the business logic may need to be converted or formatted by the business application before being sent to the sensor network 120.

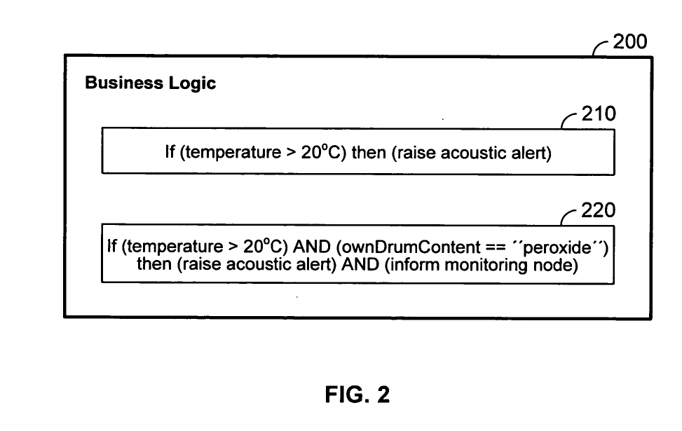

For example, FIG. 2 shows an example of business logic 200 that includes a simple rule 210 and a more complex rule 220. In this example, the business rules are expressed in the following format: “If <condition> then <action>”.

The condition can include variables referring to sensor values. During evaluation of the condition, these variables are replaced with the most current sensor values. The condition can include multiple subconditions concatenated together using a logical operator, such as “AND”, “OR”, or “NOT”.

The action specifies one or more actions to be performed when the condition is evaluated to true. Possible actions include raising an acoustic or visible alert or sending out messages across the network. The actions can also include the evaluation of further conditions. This technique is referred to as cascading. Actions can also include multiple subactions concatenated together using a logical operator. Concatenation and cascading allow for the definition of a wide range of rules of varying complexity.

Storage Monitoring

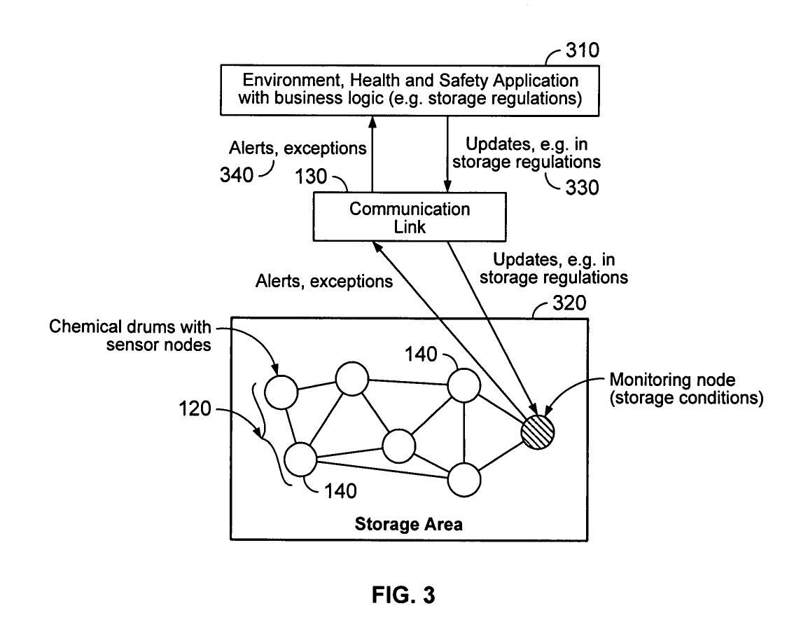

In one implementation, the above-described system is used to provide real-time monitoring of a storage area, as shown in FIG. 3.

In the example shown in FIG. 3, the business application 110 is an environment, health and safety application 310. One such application is the Product Lifecycle Management application available from SAP AG of Walldorf (Baden), Germany.

The sensor network 120 is used to monitor a storage area 320 for storing hazardous goods, for example, chemical drums. The sensor network 120 receives from the environment, health and safety application 310 a set of storage rules. The storage rules can include rules regarding storage capacity, storage conditions, and incompatible goods. An example of a storage capacity rule is a rule requiring that no more than fifty chemical drums be stored within any one hundred square meter area of the storage area.

An example of a storage condition rule is a rule requiring certain chemical drums to be stored according to a certain temperature or humidity requirements.

The incompatible goods rules dictate that certain chemicals that are particularly reactive with each other should not be stored in proximity with each other. The sensor node 140 attached to each chemical drum can contain information that identifies the item class and hazardous rating of its contents.

From time to time, the storage rules in the environment, health and safety application 310 may change. When the rules change, the environment, health and safety application 310 can send updates 330 of the storage rules to the sensor network 120 through the communication link 130.

The sensor network 120 can send alerts or exceptions 340 to the environment, health, and safety application 310 through the communication link 130. The storage rules can specify the conditions that trigger the alerts or exceptions 340.

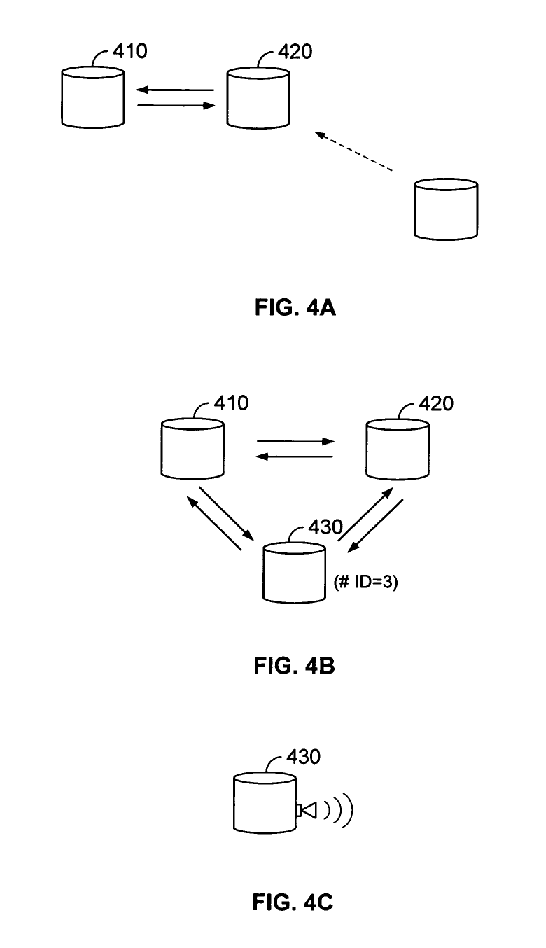

FIGS. 4A-4C illustrate execution of a storage rule through collaboration between the sensor nodes. In this example, the storage rule specifies a storage limit of two chemical drums within any storage area. Initially, as shown in FIG. 4A, the storage area contains two chemical drums 410, 420, each with an attached sensor node. The two chemical drums are in close proximity. Their sensor nodes exchange messages informing each other that they are attached to a chemical drum. As soon as a third drum 430 approaches the pair of drums, as shown in FIG. 4B, messages are exchanged between the sensor nodes for all three drums 410, 420, 430. The sensor node for the newly arrived third drum processes this information and determines that they are three drums altogether. This determination is shown by the expression in parentheses (#ID=3). Based on applying the storage limit rule, the sensor node for the third drum 430 derives a dangerous situation and communicates an alert message to each of the other sensor nodes. The sensor node for the third drum 430 can also raise an acoustic alert, as shown in FIG. 4C. The alert messages are recognized by the sensor nodes for the other drums, and these sensor nodes can raise an alert too. In addition, the monitoring node for the sensor network can generate an exception and communicate this exception to the business application. This exception can be communicated in real time, meaning that it is communicated as soon as the dangerous situation arises.

The invention and all of the functional operations described in the attached documentation can be implemented in digital electronic circuitry, or in computer software, firmware, or hardware, including the structural means disclosed in this specification and structural equivalents thereof, or in combinations of them. The invention can be implemented as one or more computer program products, i.e., one or more computer programs tangibly embodied in an information carrier, e.g., in a machine-readable storage device or in a propagated signal, for execution by, or to control the operation of, data processing apparatus, e.g., a programmable processor, a computer, or multiple computers. A computer program (also known as a program, software, software application, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file. A program can be stored in a portion of a file that holds other programs or data, in a single file dedicated to the program in question, or in multiple coordinated files (e.g., files that store one or more modules, sub-programs, or portions of code). A computer program can be deployed to be executed on one computer or on multiple computers at one site or distributed across multiple sites and interconnected by a communication network.

The processes and logic flows described in this specification, including the method steps of the invention, can be performed by one or more programmable processors executing one or more computer programs to perform functions of the invention by operating on input data and generating output. The processes and logic flows can also be performed by, and apparatus of the invention can be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

The invention can be implemented in a computing system that includes a back-end component (e.g., a data server), a middleware component (e.g., an application server), or a front-end component (e.g., a client computer having a graphical user interface or a Web browser through which a user can interact with an implementation of the invention), or any combination of such back-end, middleware, and front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

What is claimed is:

1. A computer program product, tangibly embodied in an information carrier, the computer program product being operable to cause data processing apparatus to perform operations comprising:
establishing communication between a sensor node within a sensor network and a business application;
receiving business logic from the business application; and
executing the business logic on the sensor node.

2. The computer program product of claim 1, wherein the business logic includes a set of rules, each rule specifying a condition and an action to be performed when the condition is met.

3. The computer program product of claim 2, wherein the action is to raise an alert.

4. The computer program product of claim 2, wherein executing the business logic includes resolving a rule in the set of rules.

5. The computer program product of claim 4, wherein resolving a rule in the set of rules includes:
replacing a variable in the condition with a sensor value;
determining whether the condition is met; and
if the condition is met, performing the action specified by the rule.

6. The computer program product of claim 1, wherein the operations further comprise:
detecting other sensor nodes in proximity to the sensor node; and
upon such detection, sending a message to the other sensor nodes, the message including an identifier for the sensor node and a sensor value read from the sensor on the sensor node.

7. The computer program product of claim 2, wherein the rules specify storage requirements, the storage requirements including one or more of temperature requirements, humidity requirements, storage time requirements, and storage capacity requirements.

8. The computer program product of claim 1, wherein:
the sensor network is located in a physical storage facility; and
each sensor node is attached to a physical item stored in the physical storage facility.

9. The computer program product of claim 1, wherein the sensor network includes a monitoring node that handles all communication between the sensor network and the business application.

10. A system comprising:
a business application;
a sensor network; and
a communication link between the sensor network and the business application, wherein:
the sensor network includes a plurality of sensor nodes, each sensor node being an electronic device that includes a sensor, a processor, memory, and inter-node communication logic that allows the sensor node to communicate bi-directionally with other sensor nodes in the plurality of sensor nodes; and
the sensor network is configured to receive business logic from the business application through the communication link, and to execute the business logic on the sensor nodes.

11. The system of claim 10, wherein the business logic includes a set of rules, each rule specifying a condition and an action to be performed when the condition is met.

12. The system of claim 11, wherein the action is to raise an alert.

13. The system of claim 11, wherein to execute the business logic includes to resolve a rule in the set of rules.

14. The system of claim 11, wherein to resolve a rule in the set of rules includes:
to replace a variable in the condition with a sensor value;
to determine whether the condition is met; and
if the condition is met, to perform the action specified by the rule.

15. The system of claim 10, wherein the inter-node communication logic is RF (Radio Frequency) logic.

16. The system of claim 10, wherein each sensor node is configured to:
detect other sensor nodes in proximity to the sensor node; and
upon such detection, send a message to the other sensor nodes, the message including an identifier for the sensor node and a sensor value read from the sensor on the sensor node.

17. The system of claim 11, wherein the rules specify storage requirements, the storage requirements including one or more of temperature requirements, humidity requirements, storage time requirements, and storage capacity requirements.

18. The system of claim 10, wherein:
the sensor network is located in a physical storage facility; and
each sensor node is attached to a physical item stored in the physical storage facility.

19. The system of claim 10, wherein the business application is a product lifecycle management application.

20. The system of claim 10, wherein the plurality of sensor nodes includes a monitoring node that handles all communication between the sensor network and the business application.
